(19) United States
(12) Patent Application Publication
(10) Pub. No.: US 2026/0299662 A1
(43) Pub. Date: Oct. 1, 2026

(54) SWITCHING MODE POWER SUPPLY WITH REDUCED BULK CAPACITANCE

(71) Applicant: Monolithic Power Systems, Inc., Kirkland, WA (US)

(72) Inventors: Jian Jiang, Saratoga, CA (US); Di Han, San Jose, CA (US); Rafael Alloza Lahoz, Zaragoza (ES); Enric Rodriguez Vilamitjana, Barcelona (ES)

(21) Appl. No.: 19/455,520

(22) Filed: Jan. 21, 2026

Related U.S. Application Data
(60) Provisional application No. 63/779,961, filed on Mar. 28, 2025.

(51) Int. Cl. G06F 1/30; H02M 1/088; H02M 3/158

(52) U.S. Cl. CPC G06F 1/30; H02M 1/088; H02M 3/1582

(57) ABSTRACT

A switching mode power supply with reduced bulk capacitance is discussed. The switching mode power supply receives an AC input voltage to power a load via a first power converter and a second converter. If the AC input voltage is dropped, a capacitor is discharged via an auxiliary circuit to continue power the second power converter by stepping up a voltage across the capacitor.

This application claims the benefit of U.S. Provisional Patent Application No. 63/779,961, filed Mar. 28, 2025, under 35 U.S.C. § 119(e).

### BACKGROUND OF THE INVENTION

Severs are widely used in artificial intelligent (AI) computing applications. Typically, a power supply unit (PSU) works with an input voltage (e.g., a DC bus voltage) as high as 400V to provide an appropriate voltage to the system. A bulk capacitor is placed at the input of the system, to store energy and to provide power supply to the system in case of a sudden drop of the DC bus voltage. When a voltage across the bulk capacitor drops to a voltage threshold (e.g., 380V), the system would need to shut down. Thus, the bulk capacitor with a large capacitance is required to hold a certain amount of energy to elongate the hold-up time due to a loss of the input voltage, which increases the cost and volume.

### SUMMARY OF THE INVENTION

In accordance with an embodiment of the present invention, a switching mode power supply is discussed. The switching mode power supply comprises: an input port, a first power converter, a second power converter, a first capacitor, a second capacitor, and a control circuit. The input port is configured to receive an input voltage. The first power converter is configured to convert the input voltage to an intermediate voltage. The second power converter is configured to convert the intermediate voltage to an output voltage to power a load. The first capacitor is coupled between the intermediate voltage and a reference ground. The second capacitor is coupled to the intermediate voltage via an auxiliary circuit. The control circuit is configured to control the auxiliary circuit in response to the intermediate voltage and a voltage across the second capacitor.

In addition, in accordance with an embodiment of the present invention, a switching mode power supply is discussed. The switching mode power supply comprises: a power converter, an auxiliary circuit and a control circuit. The power converter is configured to convert an intermediate voltage to an output voltage when an input voltage is plugged. The auxiliary circuit is coupled to the intermediate voltage to provide an auxiliary voltage. The control circuit is configured to control the auxiliary circuit in response to the intermediate voltage and the auxiliary voltage.

Furthermore, in accordance with an embodiment of the present invention, a switching mode power supply is discussed. The switching mode power supply comprises: a power converter, an auxiliary circuit, and a control circuit. The power converter is configured to convert an input voltage to an intermediate voltage. The auxiliary circuit is coupled to the intermediate voltage to provide an auxiliary voltage. The control circuit is configured to control the auxiliary circuit in response to the intermediate voltage and the auxiliary voltage.

### BRIEF DESCRIPTION OF DRAWINGS

FIG. 1 schematically shows a switching mode power supply 100 in accordance with an embodiment of the present invention.

FIG. 2 schematically shows a switching mode power supply 200 with a circuit configuration of the control circuit 104 in accordance with an embodiment of the present invention.

FIG. 3 schematically shows timing waveform of the input voltage Vac, the intermediate voltage Vint, and the voltage V_{C2} across the second capacitor C2 in the switching mode power supplies 100 and 200.

FIG. 4 schematically shows a switching mode power supply 400 in accordance with an embodiment of the present invention.

FIG. 5 schematically shows a switching mode power supply 500 with a circuit configuration of the control circuit 104 in accordance with an embodiment of the present invention.

FIG. 6 schematically shows timing waveform of the input voltage Vac, the intermediate voltage Vint, and the voltage V_{C2} across the second capacitor C2 in the switching mode power supplies 400 and 500.

FIG. 7 schematically shows a switching mode power supply 700 with a circuit configuration of the control circuit 104 in accordance with an embodiment of the present invention.

FIG. 8 schematically shows timing waveform of the input voltage Vac, the intermediate voltage Vint, and the voltage V_{C2} across the second capacitor C2 in the switching mode power supply 700.

FIG. 9 schematically shows a switching mode power supply 900 in accordance with an embodiment of the present invention.

### DETAILED DESCRIPTION OF THE INVENTION

Embodiments of circuits for switching mode power supply are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

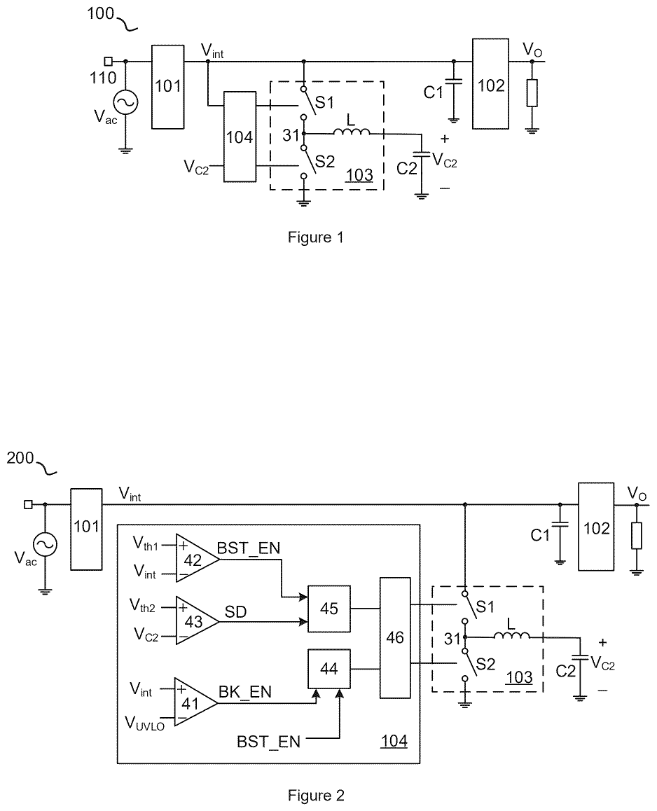

FIG. 1 schematically shows a switching mode power supply 100 in accordance with an embodiment of the present invention. In the example of FIG. 1, the switching mode power supply 100 comprises: an input port 110, configured to receive an input voltage V_{ac}; a first power converter 101, configured to convert the input voltage V_{ac} to an intermediate voltage Vᵢₙₜ; and a second power converter 102, configured to convert the intermediate voltage Vᵢₙₜ to an output voltage V_{O}, to power a load (e.g., a server). The input voltage V_{ac} may be an AC voltage delivered from an AC source. The first power converter 101 may comprise a PFC (power factor correction) circuit, and the second power converter 102 may comprise an LLC converter. The switching mode power supply 100 further comprises: a first capacitor C1, coupled between the intermediate voltage Vᵢₙₜ and a reference ground, to smooth the intermediate voltage Vᵢₙₜ; a second capacitor C2, coupled to the intermediate voltage Vᵢₙₜ via an auxiliary circuit 103; and a control circuit 104, configured to control the auxiliary circuit 103 in response to the intermediate voltage Vᵢₙₜ and a voltage V_{C2} across the second capacitor C2.

In one embodiment of the present invention, the control circuit 104 is configured to control the second capacitor C2 to be 1) charged by way of the auxiliary circuit 103 when the input voltage V_{ac} is plugged into the input port 110, to generate an auxiliary voltage V_{C2} across the second capacitor; and 2) discharged by way of the auxiliary circuit 103 when the input voltage V_{ac} is disconnected from the input port 110 and the intermediate voltage Vᵢₙₜ falls to a first voltage threshold Vₜₕ₁. In one embodiment of the present invention, the first voltage threshold Vₜₕ₁ may have a voltage value around 380V, while the intermediate voltage may be around 400V when fully charged by the input voltage V_{ac}.

In one embodiment of the present invention, the control circuit 104 is configured to control the auxiliary circuit 103 to operate at buck mode to charge the second capacitor C2 when the input voltage V_{ac} is plugged into the input port 110; and to control the auxiliary circuit 103 to operate at boost mode to discharge the second capacitor C2 when the input voltage V_{ac} is disconnected from the input port 110 and the intermediate voltage Vᵢₙₜ falls to the first voltage threshold Vₜₕ₁, to provide power supply to the second power converter 102. When a voltage V_{C2} (also called as the auxiliary voltage) across the second capacitor C2 falls to a second voltage threshold (also called as a shutdown threshold) Vₜₕ₂, the auxiliary circuit 103 is shut down. The second voltage threshold Vₜₕ₂ may have a voltage value around 100V.

In the example of FIG. 1, the auxiliary circuit 103 comprises: a first switch S1 and a second switch S2, coupled in series between the intermediate voltage Vᵢₙₜ and the reference ground; and an inductor L, coupled between the second capacitor C2 and a switch node 31 formed by a common connection of the first switch S1 and the second switch S2.

In real applications, when the input voltage V_{ac} is plugged into the input port 110, it takes time to build the intermediate voltage Vᵢₙₜ. When the intermediate voltage Vᵢₙₜ reaches an undervoltage threshold V_{UVLO} (e.g., around 120V), the second capacitor C2 is started to be charged.

FIG. 2 schematically shows a switching mode power supply 200 with a circuit configuration of the control circuit 104 in accordance with an embodiment of the present invention. As shown in FIG. 2, the control circuit 104 comprises: a first comparing circuit 41, a second comparing circuit 42, a third comparing circuit 43, a buck controller 44, a boost controller 45, and a driver 46. The first comparing circuit 41 is configured to generate a buck enable signal BK_EN when the intermediate voltage Vᵢₙₜ increases from a low voltage (e.g., 0V) and increased to be higher than the undervoltage threshold V_{UVLO}, to enable the buck controller 44, so that the auxiliary circuit 103 is controlled to operate at buck mode to charge the second capacitor C2. The second comparing circuit 42 is configured to generate a boost enable signal BST_EN when the intermediate voltage Vᵢₙₜ falls to the first threshold Vₜₕ₁, to enable the boost controller 45 and disable the buck controller 44, so that the auxiliary circuit 103 is controlled to operate at boost mode to discharge the second capacitor C2, to transfer the energy stored in the second capacitor C2 to the first capacitor C1 and power the second power converter 102. The third comparing circuit 43 is configured to generate a shutdown signal SD when the voltage V_{C2} across the second capacitor C2 falls to a second threshold Vₜₕ₂ from a relatively high voltage, to shut down (i.e. disable) the boost controller 45.

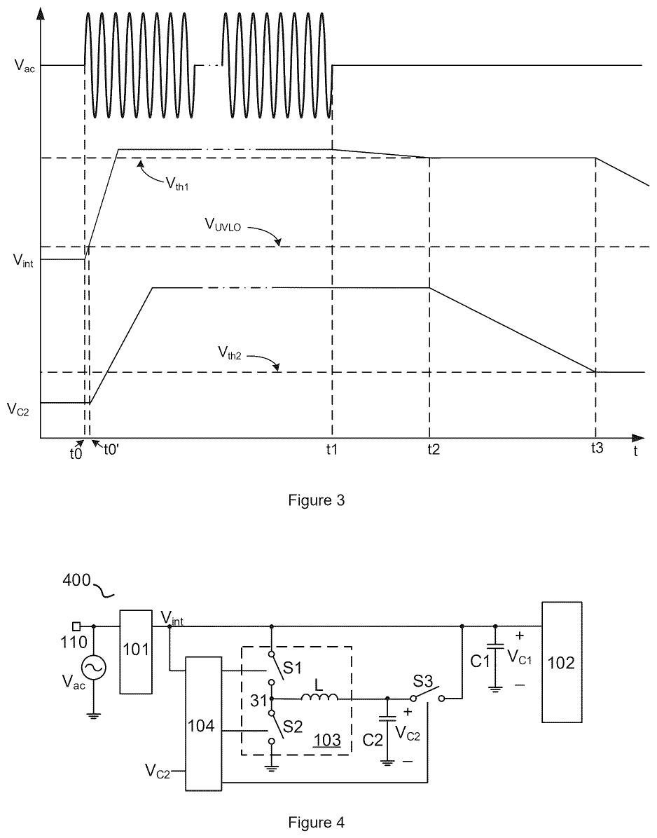

The timing waveforms of the input voltage V_{ac}, the intermediate voltage Vᵢₙₜ, and the voltage V_{C2} across the second capacitor C2 in the switching mode power supplies 100 and 200 are schematically shown in FIG. 3.

As shown in FIG. 3, at time point t0, the input voltage V_{ac} is plugged into the input port 110. The system starts to work. The intermediate voltage Vᵢₙₜ increases to a maximum instantaneous value of the input voltage within a very short time period. The second capacitor C2 starts to be charged via the auxiliary circuit 103 at time point t0′ when the intermediate voltage Vᵢₙₜ increases to the undervoltage threshold V_{UVLO}.

At time point t1, the input voltage V_{ac} is disconnected from the input port 110, i.e. the system loses the input voltage V_{ac}. Then the first capacitor C1 is discharged to act as a power source to power the second power converter 102. Accordingly, the intermediate voltage Vᵢₙₜ starts to decrease.

At time point t2, the intermediate voltage Vᵢₙₜ falls to the first voltage threshold Vₜₕ₁, which is detected by the control circuit 104 (e.g., the second comparing circuit 42). Accordingly, the boost controller 45 is enabled to control the auxiliary circuit 103 to operate at boost mode to discharge the second capacitor C2, and to provide a step-up voltage, so as to maintain the intermediate voltage Vᵢₙₜ to be not below the first voltage threshold Vₜₕ₁. The voltage V_{C2} across the second capacitor C2 starts to decrease; and the intermediate voltage Vᵢₙₜ stops decreasing because of the boost function of the auxiliary circuit 103.

At time point t3, the voltage V_{C2} across the second capacitor C2 falls to the second voltage threshold Vₜₕ₂. The second capacitor C2 no longer has sufficient energy to power the second power converter 102. The boost controller 45 is shut down. The first capacitor C1 alone powers the second power converter 102 and the intermediate voltage Vᵢₙₜ starts to decrease again.

FIG. 4 schematically shows a switching mode power supply 400 in accordance with an embodiment of the present invention. The switching mode power supply 400 in FIG. 4 is similar to the switching mode power supply 100 in FIG. 1, with a difference that in the example of FIG. 4, the switching mode power supply 400 further comprises: an auxiliary switch S3, coupled between the intermediate voltage Vᵢₙₜ and the second capacitor C2. The auxiliary switch S3 is controlled by the control circuit 104.

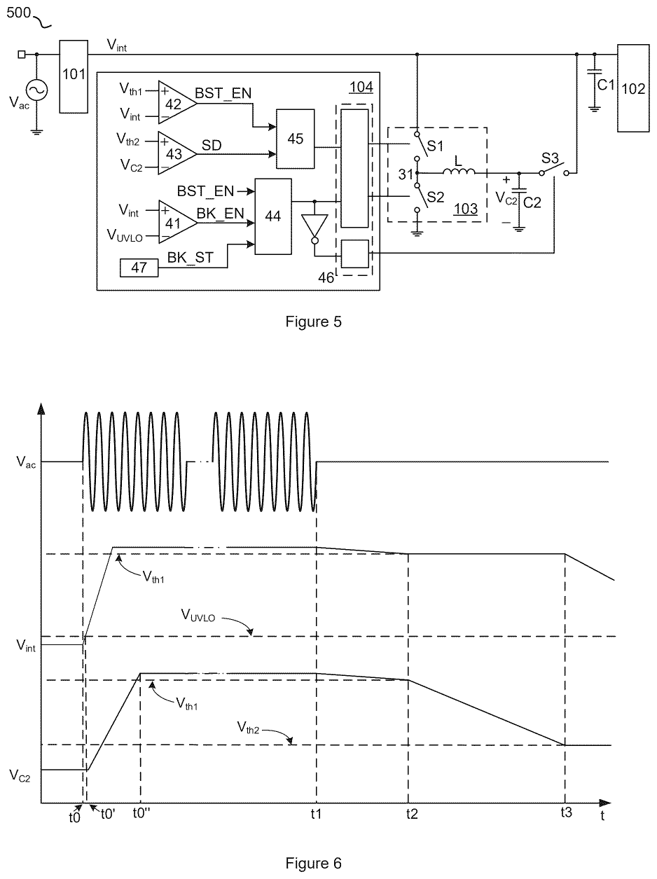

In one embodiment of the present invention, when the input voltage V_{ac} is plugged into the input port 110, the control circuit 104 is configured to 1) control the auxiliary switch S3 to be turned off, and 2) control the auxiliary circuit 103 to operate at buck mode to charge the second capacitor C2. When the second capacitor C2 is charged by way of the auxiliary circuit 103 for a certain time period or when the voltage V_{C2} across the second capacitor C2 increases to a voltage reference, the auxiliary circuit 103 is disabled and the auxiliary switch S3 is turned on, so that the second capacitor C2 and the first capacitor C1 are coupled in parallel to smooth the intermediate voltage Vᵢₙₜ. When the input voltage V_{ac} is disconnected from the input port 110, and the intermediate voltage Vᵢₙₜ falls to the first voltage threshold Vₜₕ₁, the control circuit 104 is configured to 1) control the auxiliary switch S3 to be turned off, and 2) control the auxiliary circuit 103 to operate at boost mode to discharge the second capacitor C2 to power the second power converter 102. The corresponding circuit configuration of the control circuit is schematically shown in FIG. 5. As shown in FIG. 5, the control circuit 104 comprises: the first comparing circuit 41, the second comparing circuit 42, the third comparing circuit 43, the buck controller 44, the boost controller 45, and the driver 46 as that in FIG. 2. Different with the embodiment shown in FIG. 2, the control circuit 104 in the switching mode power supply 500 further comprises: a stop circuit 47, configured to generate a buck stop signal BK_ST 1) when the auxiliary circuit 103 has operated at buck mode for a certain time period, or 2) when the voltage V_{C2} across the second capacitor C2 reaches a certain voltage value (e.g., when V_{C2} reaches the voltage reference), to disable the buck controller 44 and turn on the auxiliary switch S3.

The timing waveforms of the input voltage V_{ac}, the intermediate voltage Vᵢₙₜ, and the voltage V_{C2} across the second capacitor C2 in the switching mode power supplies 400 and 500 are schematically shown in FIG. 6.

As shown in FIG. 6, at time point t0, the input voltage V_{ac} is plugged into the input port 110. The system starts to work. The intermediate voltage Vᵢₙₜ increases to the maximum instantaneous value of the input voltage within a very short time period. The second capacitor C2 starts to be charged by way of the auxiliary circuit 103 at time point t0′ when the intermediate voltage Vᵢₙₜ increases to the undervoltage threshold V_{UVLO}.

At time point t1, the input voltage V_{ac} is disconnected from the input port 110. As discussed above, the buck controller 44 is disabled and the auxiliary switch S3 is turned on 1) when the auxiliary circuit 103 has operated at buck mode for a certain time period, or 2) when the voltage V_{C2} across the second capacitor C2 reaches a certain voltage value (e.g. at time point t0″), which happen before time point T1. Thus, the buck controller 44 has been disabled and the auxiliary switch S3 has been turned on at time point T1. Then the first capacitor C1 and the second capacitor C2 are both discharged to act as power sources to power the second power converter 102. Accordingly, the intermediate voltage Vᵢₙₜ and the voltage V_{C2} across the second capacitor C2 both start to decrease.

At time point t2, the intermediate voltage Vᵢₙₜ falls to the first voltage threshold Vₜₕ₁, which is detected by the control circuit 104 (e.g., the second comparing circuit 42). Accordingly, the auxiliary switch S3 is turned off, and the boost controller 45 is enabled to control the auxiliary circuit 103 to operate at boost mode to discharge the second capacitor C2, and to provide a step-up voltage, so as to maintain the intermediate voltage Vᵢₙₜ to be not below the first voltage threshold Vₜₕ₁. The voltage V_{C2} across the second capacitor C2 starts to decrease; and the intermediate voltage Vᵢₙₜ stops decreasing because of the boost function of the auxiliary circuit 103.

At time point t3, the voltage V_{C2} across the second capacitor C2 falls to the second voltage threshold Vₜₕ₂. The second capacitor C2 no longer has sufficient energy to power the second power converter 102. The boost controller 45 is shut down. The first capacitor C1 alone powers the second power converter 102 and the intermediate voltage Vᵢₙₜ starts to decrease again.

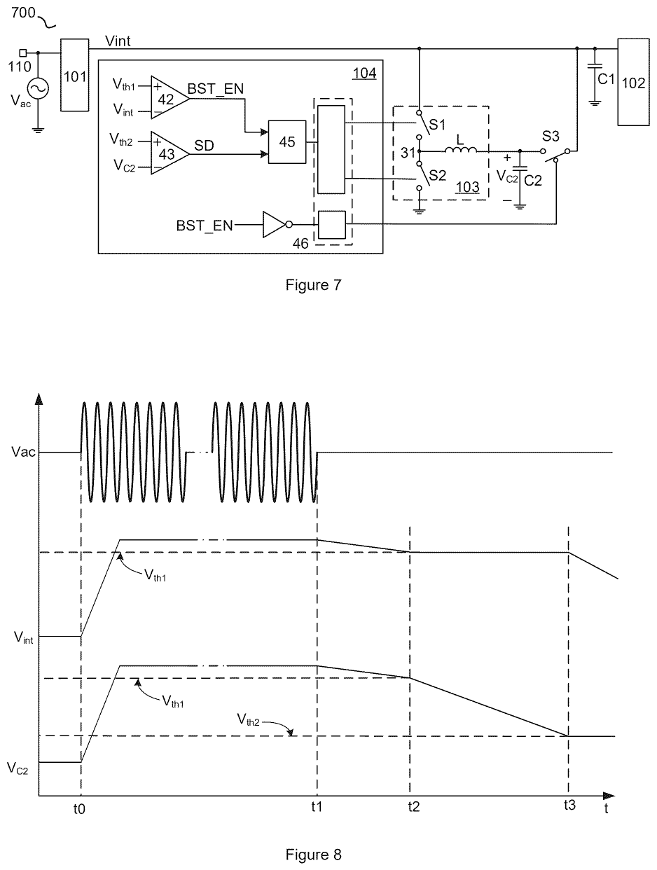

In another embodiment of the present invention, when the input voltage V_{ac} is plugged into the input port 110, the control circuit 104 is configured to 1) control the auxiliary circuit 103 to be idle, and 2) control the auxiliary switch S3 to be turned on to charge the second capacitor C2. When the input voltage V_{ac} is disconnected from the input port 110, and the intermediate voltage Vᵢₙₜ falls to the first voltage threshold Vₜₕ₁, the control circuit 104 is configured to 1) control the auxiliary switch S3 to be turned off, and 2) control the auxiliary circuit 103 to operate at boost mode to discharge the second capacitor C2. The corresponding circuit configuration of the control circuit is schematically shown in FIG. 7. As shown in FIG. 7, the control circuit 104 comprises: the second comparing circuit 42, the third comparing circuit 43, the boost controller 45, and the driver 46. The auxiliary switch S3 is turned on when the input voltage V_{ac} is plugged to the input port 110. The second comparing circuit 42 is configured to generate a boost enable signal BST_EN when the intermediate voltage Vᵢₙₜ falls to the first threshold Vₜₕ₁, to enable the boost controller 45 and turn off the auxiliary switch S3. The third comparing circuit 43 is configured to generate a shutdown signal SD when the voltage V_{C2} across the second capacitor C2 falls to a second threshold Vₜₕ₂, to shut down the boost controller 45.

In the example of FIG. 7, the auxiliary switch S3 may comprise a power switch that is turned on when a low voltage (e.g., a logic signal with a voltage lower than 1V) is applied to its control terminal, and is turned off when a high voltage (e.g., a logic signal with a voltage higher than 2V) is applied to its control terminal.

In the example of FIG. 7, the driver 46 includes two sub-drivers 461 and 462. The sub-driver 461 is used to drive the first switch S1 and the second switch S2; and the sub-driver 462 is used to drive the auxiliary switch S3. However, one skilled in the art should realize that the driver 46 may comprise desired number of sub-drivers, to drive the first switch S1, the second switch S2, and the auxiliary switch S3.

The timing waveforms of the input voltage V_{ac}, the intermediate voltage Vᵢₙₜ, and the voltage V_{C2} across the second capacitor C2 in the switching mode power supply 700 are schematically shown in FIG. 8.

As shown in FIG. 8, at time point t0, the input voltage V_{ac} is plugged into the input port 110. The system starts to work. The auxiliary switch S3 is on. The intermediate voltage Vᵢₙₜ and the voltage V_{C2} across the second capacitor C2 increase to the maximum instantaneous value of the input voltage within a very short time period.

At time point t1, the input voltage V_{ac} is disconnected from the input port 110. The first capacitor C1 and the second capacitor C2 are both discharged to act as power sources to power the second power converter 102. Accordingly, the intermediate voltage Vᵢₙₜ and the voltage V_{C2} across the second capacitor C2 both start to decrease.

At time point t2, the intermediate voltage Vᵢₙₜ falls to the first voltage threshold Vₜₕ₁, the auxiliary switch S3 is turned off, and the boost controller 45 is enabled to control the auxiliary circuit 103 to operate at boost mode to discharge the second capacitor C2, and to provide a step-up voltage, so as to maintain the intermediate voltage Vᵢₙₜ to be not below the first voltage threshold Vₜₕ₁. The voltage V_{C2} across the second capacitor C2 starts to decrease; and the intermediate voltage Vᵢₙₜ stops decreasing because of the boost function of the auxiliary circuit 103.

At time point t3, the voltage V_{C2} across the second capacitor C2 falls to the second voltage threshold Vₜₕ₂. The second capacitor C2 no longer has sufficient energy to power the second power converter 102. The boost controller 45 is shut down. The first capacitor C1 alone powers the second power converter 102 and the intermediate voltage Vᵢₙₜ starts to decrease again.

In one embodiment of the present invention, the first switch S1, the second switch S2, and the auxiliary switch S3 are all controllable switches, which may comprise MOSFETs, IGBTs, BJTs, etc.

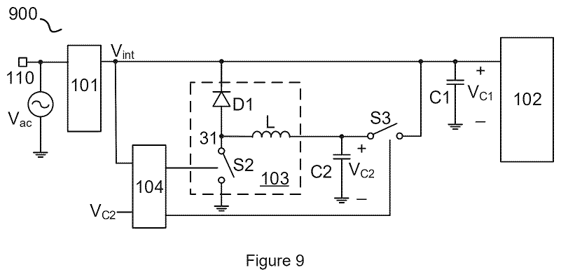

FIG. 9 schematically shows a switching mode power supply 900 in accordance with an embodiment of the present invention. The switching mode power supply 900 in FIG. 9 is similar to the switching mode power supply 400 in FIG. 4, with a difference that in the example of FIG. 9, the first switch S1 in the auxiliary circuit 103 is replaced by a diode D1. The diode D1 has an anode coupled to the switch node 31 and a cathode coupled to the first capacitor C1. In the example of FIG. 9, when the input voltage V_{ac} is plugged into the input port 110, the auxiliary circuit 103 is idle, the auxiliary switch S3 is turned on, and the second capacitor C2 is charged by way of the auxiliary switch S3. When the input voltage V_{ac} is disconnected from the input port 110, and the intermediate voltage Vᵢₙₜ falls to the first voltage threshold Vₜₕ₁, the control circuit 104 is configured to control the auxiliary circuit 103 to operate at boost mode to discharge the second capacitor C2. The control of the second switch S2 and the auxiliary switch S3 in the switching mode power supply 900 is similar to that of the switching mode power supply 700 in FIG. 7. The timing waveforms of the input voltage V_{ac}, the intermediate voltage Vᵢₙₜ, and the voltage V_{C2} across the second capacitor C2 in the switching mode power supply 900 are same as that shown in FIG. 8.

As seen from FIG. 3, FIG. 6 and FIG. 8, the hold-up time since the loss of the input voltage is elongated from the time interval t1-t2 to t1-t3. That is, an addition hold-up time from time point t2 to time point t3 is obtained. Thus, the capacitance of the first capacitor (i.e. the bulk capacitor) is needn't to be increased. Thus, the cost and volume are both lowered down.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A switching mode power supply, comprising:
an input port, configured to receive an input voltage;
a first power converter, configured to convert the input voltage to an intermediate voltage;
a second power converter, configured to convert the intermediate voltage to an output voltage to power a load;
a first capacitor, coupled between the intermediate voltage and a reference ground;
a second capacitor, coupled to the intermediate voltage via an auxiliary circuit; and
a control circuit, configured to control the auxiliary circuit in response to the intermediate voltage and a voltage across the second capacitor.

2. The switching mode power supply of claim 1, wherein the control circuit is configured to control the second capacitor to be:
1) charged by way of the auxiliary circuit when the input voltage is plugged into the input port; and
2) discharged by way of the auxiliary circuit when a) the input voltage is disconnected from the input port and b) the intermediate voltage falls to a first voltage threshold.

3. The switching mode power supply of claim 1, wherein:
the auxiliary circuit is shut down when a voltage across the second capacitor falls to a shutdown threshold.

4. The switching mode power supply of claim 1, further comprising:
an auxiliary switch, coupled between the intermediate voltage and the second capacitor.

5. The switching mode power supply of claim 4, wherein:
when the input voltage is plugged into the input port, the control circuit is configured to 1) control the auxiliary switch to be turned off; and 2) control the auxiliary circuit to operate at buck mode to charge the second capacitor;
when the second capacitor is charged by way of the auxiliary circuit for a certain time period or when the voltage across the second capacitor increases to a voltage reference, the auxiliary circuit is disabled and the auxiliary switch is turned on; and
when the input voltage is disconnected from the input port and the intermediate voltage falls to a first voltage threshold, the control circuit is configured to 1) control the auxiliary switch to be turned off; and 2) control the auxiliary circuit to operate at boost mode to discharge the second capacitor to power the second power converter.

6. The switching mode power supply of claim 4, wherein when the input voltage is plugged into the input port, the control circuit is configured to:
1) control the auxiliary circuit to be idle; and
2) control the auxiliary switch to be turned on to charge the second capacitor.

7. The switching mode power supply of claim 6, wherein when the input voltage is disconnected from the input port and the intermediate voltage falls to a first voltage threshold, the control circuit is configured to:
1) control the auxiliary switch to be turned off; and
2) control the auxiliary circuit to operate at boost mode to discharge the second capacitor.

8. A switching mode power supply, comprising:
a power converter, configured to convert an intermediate voltage to an output voltage when an input voltage is plugged;
an auxiliary circuit, coupled to the intermediate voltage to provide an auxiliary voltage; and
a control circuit, configured to control the auxiliary circuit in response to the intermediate voltage and the auxiliary voltage.

9. The switching mode power supply of claim 8, wherein the auxiliary circuit is controlled to operate at:
1) buck mode to convert the intermediate voltage to the auxiliary voltage when the input voltage is plugged; and
2) boost mode to convert the auxiliary voltage to the intermediate voltage when a) the input voltage drops out; and b) the intermediate voltage falls to a first voltage threshold.

10. The switching mode power supply of claim 8, wherein:
the auxiliary circuit is shut down when the auxiliary voltage falls to a shutdown threshold.

11. The switching mode power supply of claim 8, further comprising:
an auxiliary switch, coupled between the intermediate voltage and auxiliary voltage.

12. The switching mode power supply of claim 11, wherein:
when the input voltage is plugged into the input port, the control circuit is configured to:
1) control the auxiliary switch to be turned off; and 2) control the auxiliary circuit to operate at buck mode to convert the intermediate voltage to the auxiliary voltage;
when the auxiliary circuit has operated at buck mode for a certain time period or when the auxiliary voltage increases to a voltage reference, the auxiliary circuit is disabled and the auxiliary switch is turned on; and
when the input voltage drops out and the intermediate voltage falls to a first voltage threshold, the control circuit is configured to: 1) control the auxiliary switch to be turned off; and 2) control the auxiliary circuit to operate at boost mode to converter the auxiliary voltage to the intermediate voltage.

13. The switching mode power supply of claim 8, wherein:
when the input voltage is plugged, the control circuit is configured to 1) control the auxiliary circuit to be idle; and 2) control the auxiliary switch to be turned on; and
when the input voltage drops out and the intermediate voltage falls to a first voltage threshold, the control circuit is configured to 1) control the auxiliary switch to be turned off; and
2) control the auxiliary circuit to operate at boost mode to converter the auxiliary voltage to the intermediate voltage.

14. The switching mode power supply of claim 8, wherein the power converter is a first power converter, and wherein switching mode power supply further comprises:
a second power converter, configured to convert the input voltage to the intermediate voltage.

15. A switching mode power supply, comprising:
a power converter, configured to convert an input voltage to an intermediate voltage;
an auxiliary circuit, coupled to the intermediate voltage to provide an auxiliary voltage; and
a control circuit, configured to control the auxiliary circuit in response to the intermediate voltage and the auxiliary voltage.

16. The switching mode power supply of claim 15, wherein the auxiliary circuit is controlled to operate at:
1) buck mode to convert the intermediate voltage to the auxiliary voltage when the input voltage is plugged; and
2) boost mode to convert the auxiliary voltage to the intermediate voltage a) after the input voltage drop out; and b) when the intermediate voltage falls to a first voltage threshold.

17. The switching mode power supply of claim 15, wherein:
the auxiliary circuit is shut down when the auxiliary voltage falls to a shutdown threshold.

18. The switching mode power supply of claim 15, further comprising:
an auxiliary switch, coupled between the intermediate voltage and auxiliary voltage.

19. The switching mode power supply of claim 18, wherein:
when the input voltage is plugged into the input port, the control circuit is configured to:
1) control the auxiliary switch to be turned off; and 2) control the auxiliary circuit to operate at buck mode to convert the intermediate voltage to the auxiliary voltage;
when auxiliary circuit to operate at buck mode for a certain time period or when the auxiliary voltage increases to a voltage reference, the auxiliary circuit is disabled and the auxiliary switch is turned on; and
when the input voltage drops out and the intermediate voltage falls to a first voltage threshold, the control circuit is configured to: 1) control the auxiliary switch to be turned off; and 2) control the auxiliary circuit to operate at boost mode to converter the auxiliary voltage to the intermediate voltage.

20. The switching mode power supply of claim 18, wherein:
when the input voltage is plugged, the control circuit is configured to 1) control the auxiliary circuit to be idle; and 2) control the auxiliary switch to be turned on; and
when the input voltage drops out and the intermediate voltage falls to the first voltage threshold, the control circuit is configured to 1) control the auxiliary switch to be turned off; and
2) control the auxiliary circuit to operate at boost mode to converter the auxiliary voltage to the intermediate voltage.
